(19) United States
(12) Patent Application Publication
(10) Pub. No.: US 2025/0269283 A1
(43) Pub. Date: Aug. 28, 2025

(54) METHOD FOR DYNAMIC IMAGE EDITING, ELECTRONIC DEVICE, AND NON-TRANSITORY COMPUTER-READABLE STORAGE MEDIUM

(71) Applicant: NETEASE (HANGZHOU) NETWORK CO., LTD., Hangzhou, Zhejiang (CN)

(72) Inventors: Jianwu HUANG, Hangzhou, Zhejiang (CN); Ting HUANG, Hangzhou, Zhejiang (CN)

(73) Assignee: NETEASE (HANGZHOU) NETWORK CO., LTD., Hangzhou, Zhejiang (CN)

(21) Appl. No.: 18/857,537

(22) PCT Filed: Sep. 22, 2022
(86) PCT No.: PCT/CN2022/120547

§ 371 Date: Oct. 17, 2024

(30) Foreign Application Priority Data
May 30, 2022 (CN) 202210598199.7

(51) Int. Cl. A63F 13/60; A63F 13/52; G06T 3/60; G06T 11/60; G06T 13/80

(52) U.S. Cl. CPC A63F 13/60; A63F 13/52; G06T 3/60; G06T 11/60; G06T 13/80

(57) ABSTRACT

A method for dynamic image editing, includes: in response to a loading operation for a first target resource, rendering and displaying a first dynamic image corresponding to the first target resource in the graphical user interface based on a first rendering texture; and in response to a first operation for the image editing control displaying an edited target dynamic image on the preview interface.

### CROSS REFERENCE TO RELATED APPLICATIONS

The present application is a National Stage Application of International Application No. PCT/CN2022/120547 filed on Sep. 22, 2022 which is based upon and claims priority to Chinese Patent Application No. 202210598199.7 entitled “Method for dynamic image editing, apparatus, and electronic device”, filed on May 30, 2022, and the content of both of which is incorporated here by reference in its entirety for all purposes.

### TECHNICAL FIELD

The present disclosure relates to the field of game technology, and in particular, to a method for dynamic image editing, an apparatus, and an electronic device.

### BACKGROUND

In a game development process, a skeletal animation usually needs to be made. In the related art, a Spine tool (for making 2D skeletal animation) is generally used to make skeletal animation resources. However, in an actual game development process, due to the diversity of game scenes, it usually needs to perform proportion setting, cropping or other editing on skeletal animation resources, generate skeletal animations with different effects, and display animation effects in real time, so as to adapt to different game scenes. However, the Spine tool does not have the functions of animation editing and real-time display of editing effects. Therefore, the static picture of the skeletal animation resource is usually edited in an image processing software (Adobe Photoshop, referred to as “PS”); then, the edited resource is uploaded to the server; and after packaged, the resource can be loaded into the game scene to view the effect.

### SUMMARY

In a first aspect, there is provided a method for dynamic image editing according to embodiments of the present disclosure; a graphical user interface is provided by a terminal device; the graphical user interface includes an image editing control and a preview interface; and the method includes: in response to a loading operation for a first target resource, rendering and displaying a first dynamic image corresponding to the first target resource in the graphical user interface based on a first rendering texture; and in response to a first operation for the image editing control, displaying an edited target dynamic image on the preview interface. In a second aspect, there is provided an electronic device according to embodiments of the present disclosure, and the electronic device includes a processor and a memory, where the memory stores a computer-executable instruction executable by the processor, and the processor executes the computer-executable instruction to implement the method for dynamic image editing in the first aspect.

In a third aspect, there is provided a non-transitory computer-readable storage medium according to embodiments of the present disclosure, where the non-transitory computer-readable storage medium stores a computer-executable instruction, and when the computer-executable instruction is invoked and executed by a processor, the computer-executable instruction enables the processor to implement the method for dynamic image editing in the first aspect.

### BRIEF DESCRIPTION OF THE DRAWINGS

FIG. 1 is a flowchart of a method for dynamic image editing according to one or more embodiments of the present disclosure;

FIG. 2 is a schematic diagram of a graphical user interface according to one or more embodiments of the present disclosure;

FIG. 3 is a schematic diagram of another graphical user interface according to one or more embodiments of the present disclosure;

FIG. 4 is a schematic diagram of another graphical user interface according to one or more embodiments of the present disclosure;

FIG. 5 is a schematic diagram of another graphical user interface according to one or more embodiments of the present disclosure;

FIG. 6 is a schematic diagram of an editing interface according to one or more embodiments of the present disclosure;

FIG. 7 is a schematic diagram of another graphical user interface according to one or more embodiments of the present disclosure;

FIG. 8 is a schematic diagram of another graphical user interface according to one or more embodiments of the present disclosure;

FIG. 9 is a schematic diagram of a first edge interface according to one or more embodiments of the present disclosure;

FIG. 10 is a schematic diagram of a target dynamic image according to one or more embodiments of the present disclosure;

FIG. 11 is a schematic diagram of another graphical user interface according to one or more embodiments of the present disclosure;

FIG. 12 is a schematic diagram of a game interface according to one or more embodiments of the present disclosure;

FIG. 13 is a schematic diagram of a comparison interface according to one or more embodiments of the present disclosure;

FIG. 14 is a schematic structural diagram of an apparatus for dynamic image editing according to one or more embodiments of the present disclosure;

FIG. 15 is a schematic structural diagram of an electronic device according to one or more embodiments of the present disclosure.

### DETAILED DESCRIPTION

In order to make the objectives, technical solutions, and advantages of the embodiments of the present disclosure clearer, the technical solutions of the present disclosure will be clearly and completely described below with reference to the accompanying drawings. Obviously, the described embodiments are partial embodiments of the present disclosure, not all the embodiments. All other embodiments obtained by those skilled in the art based on the embodiments of the present disclosure without creative efforts shall fall within the protection scope of the present disclosure.

In the current game development process, a skeletal animation usually needs to be made. In the related art, a Spine tool (for making 2D skeletal animation) is generally used to make skeletal animation resources. However, in an actual game development process, due to the diversity of game scenes, it usually needs to perform proportion setting, cropping or other editing on skeletal animation resources, generate skeletal animations with different effects, and display animation effects in real time, so as to adapt to different game scenes. However, the Spine tool does not have the functions of animation editing and real-time display of editing effects. Therefore, the static picture of the skeletal animation resource is usually edited in an image processing software (Adobe Photoshop, referred to as “PS”); then, the edited resource is uploaded to the server; and after packaged, the resource can be loaded into the game scene to view the effect. In this manner, the operation is tedious, the labor cost and time cost are relatively higher, and there is relatively less editing function, which cannot meet the requirements of developers.

In addition, the Spine tool can implement the function of outputting a dynamical resource for character design, but cannot convert the resource into an edited dynamic image effect.

Moreover, it is unable to support viewing the effect in real time in the game; it is unable to conveniently and quickly edit position, size, zoom, etc.; it is unable to process the edge blurring; it is unable to perform mirror; it is unable to quickly store the static PNG picture; it is unable to view the voice effect matched with the mouth shape; it is unable to be well combined with the plot editor so as to freely invoke the resource in cooperation with the plot editor; it is unable to add the emotion action according to the line word of the plot, and add changes in character dynamics and expressions; and the operation is inconvenient, the process needs multi-party cooperation, the time span is long, the process is too tedious, and it is not suitable for large-batch processing. Based on this, according to the embodiments of the present disclosure, there is provided a method for dynamic image editing, apparatus, and electronic device, the technology of which may be applied to an electronic device having a dynamic image or animation editing function, such as a computer or a notebook computer, etc.

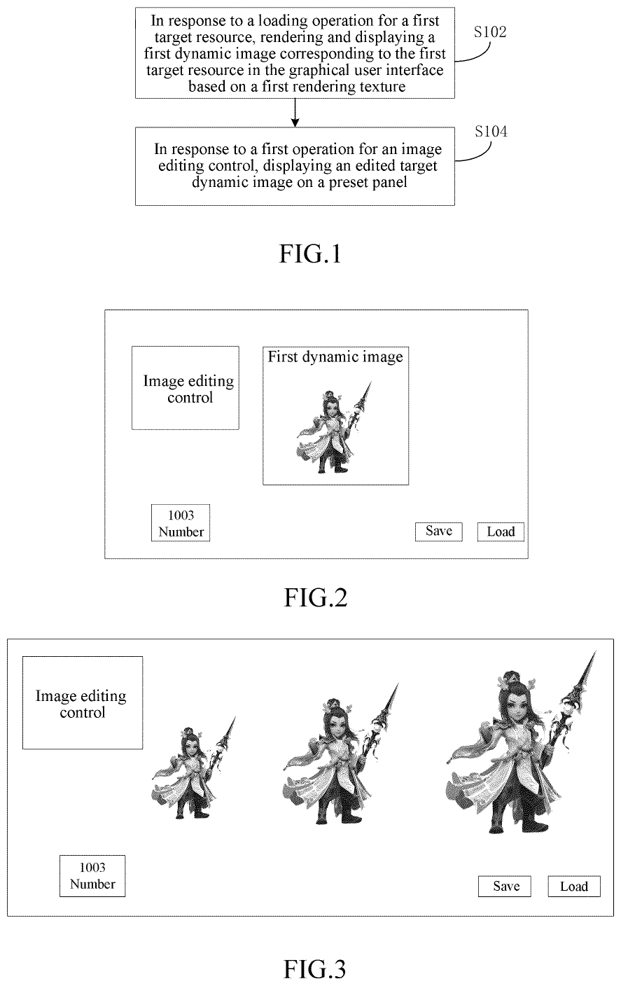

In order to facilitate understanding of the embodiments, the method for dynamic image editing disclosed by the embodiments of the present disclosure is firstly described in detail, where a graphical user interface is provided by a terminal device, and the graphical user interface includes an image editing control and a preview interface. As shown in FIG. 1, the method includes the following steps.

In step S102, in response to a loading operation for a first target resource, a first dynamic image corresponding to the first target resource is rendered and displayed in the graphical user interface based on a first rendering texture.

The first target resource generally refers to a dynamic resource for character design made by the Spine animation tool. The first rendering texture may also be represented as Render Texture, which is mainly used to render a dynamic image in the first target resource into the first rendering texture, and then display it in the graphical user interface. The first dynamic image may be a dynamic portrait, a dynamic virtual object in a game, such as a steed, a task character, or the like. In some embodiments, Render Texture is a general rendering texture created and updated during running, the object to be rendered may be filled into it and then be used in the game as an ordinary texture, such as, to create a picture control, etc.

In some embodiments, since the first target resource is a combined graph combined by scatter graphs, that is, it is a 2D skeletal animation graph and is a combined graph in which the picture related to each skeleton part is combined into a large graph, but it is not a complete dynamic graph, it is thus not facilitated for display processing. In order to achieve a better display effect, resource rendering and display are performed by using the first rendering texture.

During actual implementation, as shown in FIG. 2, the number of the first target resource to be loaded (such as 1003 in FIG. 2) is input into the number control, the loading control is clicked, then the first target resource may be loaded into the editor by using the Spine module in the game engine, and the first target resource may be rendered in the editor and displayed onto the graphical user interface of the editor. In some embodiments, the first rendering texture may be dynamically created, the animation in the first target resource may be rendered onto the first rendering texture, and then the rendered first rendering texture may be displayed on the graphical user interface; In some embodiments, the rendered first rendering texture may be attached onto the graphical user interface and displayed in the game.

In step S104, in response to a first operation for the image editing control, the edited target dynamic image is displayed on the preview interface.

The image editing control is mainly used to edit a size and a position of the first dynamic image, and perform mirror on the first dynamic image, etc. The first operation may be a click operation, a click moving operation, a scrolling operation, or the like. Different operations are usually needed for different editing controls. The preview interface may also be represented as a Panel, which may be understood as a UI interface, and the preview interface has a cropping function for cropping the first dynamic image.

For example, the first operation may be performed for the image editing control with the cropping function, and the first dynamic image may be provided on the preview interface by using the cropping function of the control preview interface of the game engine UI module; that is, the rendered first rendering texture is provided on the Panel, the preview interface may be cropped into shapes of different sizes, and then partial regions of the first dynamic image, such as the head region, the half-body region, or the like, may be displayed in the shape, thus implementing the effect of cropping and editing the first dynamic image and displaying the first dynamic image.

For another example, a zoom-in or zoom-out operation may be performed for the image editing control having a zoom function, so that the size of the first dynamic image may be zoomed in or zoomed out; that is, the rendered first rendering texture is changed, the zoomed-in or zoomed-out first dynamic image is displayed on the image user interface, and if a cropping operation has been performed, a zoomed-in or zoomed-out target dynamic image may be displayed.

For another example, a moving operation may be performed on the displayed dynamic image to change the display position of the first dynamic image, and the dynamic image after the position is changed may be displayed.

During actual implementation, the first dynamic image may be edited on the preview interface in response to the first operation for the image editing control, and the edited target dynamic image may be displayed on the preview interface. The editing operations are all based on the preview interface for editing. After the editing is completed, the target dynamic image is displayed on the graphical user interface.

According to embodiments of the present disclosure, there is provided a method for dynamic image editing. In response to a loading operation for a first target resource, a first dynamic image corresponding to the first target resource is rendered and displayed in the graphical user interface based on a first rendering texture; and in response to a first operation for an image editing control in the graphical user interface, an edited target dynamic image is displayed on a preview interface. In this way, the dynamic image can be directly edited based on the preview interface, the display effect of the edited dynamic image can be viewed in real time through the rendering texture, and the saved result can be directly applied to the game, thus avoiding the problem that the dynamic image needs to be developed in a plurality of software, simplifying the development process of the game, reducing the labor cost and the time cost, and improving the development efficiency.

After step S104, the method further includes: in response to a saving operation for the target dynamic image, converting data information corresponding to the target dynamic image into a target code, and saving the target code in a preset configuration file.

In some embodiments, as shown in FIG. 2, data information corresponding to the target dynamic image may be saved by clicking a saving control displayed in the graph. The data information may be the edited target dynamic image, or may be a static image of the target dynamic image, or may be editing data in the editing process, such as the cropping size, the zoom scale, the moving position, or other data. The target code refers to a code of the target script language. The objective of converting the data information corresponding to the target dynamic image into the target code is that, in an actual game, the target code may be read by a program script configured for the game, so that the configuration file may be subsequently provided to the game interface for use.

In some embodiments, in actual game development, if the Lua script language is used for file reading and loading, the data information corresponding to the target dynamic image may be converted into the code of the Lua script language and saved to the preset configuration file config.lua. The configuration file config.lua is mainly used to be subsequently provided to the game interface for use. Therefore, if the Lua script language is used in the actual game, it may have a better performance to use the configuration form of Lua in the editor.

In addition, it should be noted that, in the embodiment, based on the first target resource, a plurality of functional interfaces are actually encapsulated for the editor. Editing, viewing, and storage of the resource may be performed in real time through the editor, and finally the edited first target resource may be output. The output file usually includes a dynamic image, a static image, various parameters configured in the editor, or the like. The parameters usually include the cropping size, the moving position, whether to flip, etc.

The manner of directly rendering the resource to the graphical user interface for display has a single function, which is not conducive to subsequent editing of the dynamic image displayed on the graphical user interface with various effects. In order to improve the display effect and realize additional editing functions, in the above step S102, for the step of rendering and displaying the first dynamic image corresponding to the first target resource in the graphical user interface based on the first rendering texture, a possible implementation is as follows. The first target resource is loaded; the first target rendering texture is obtained by creating the first rendering texture and rendering the first target resource onto the first rendering texture frame by frame; and the first target rendering texture is determined as the first dynamic image, and the first dynamic image is displayed in the first display region of the graphical user interface; where the display priority of the first dynamic image is higher than the display priority of the image editing control, the first dynamic image includes a plurality of first dynamic images, and the size of each first dynamic image is different from each other.

Actually, a plurality of first dynamic images of different sizes may be displayed on the graphical user interface. For example, as shown in FIG. 3, three first dynamic images of different sizes are displayed. Therefore, during actual implementation, a plurality of first rendering textures of different sizes may be created, and mainly used to render and display first dynamic images of different sizes, where the size of each first rendering texture needs to be the same as a preset size in the editor. In some embodiments, a plurality of first rendering textures (i.e., Render Texture) of different sizes may be dynamically created by using a Render Texture module of the game engine, and the first target resource may be rendered onto different first rendering textures. In some embodiments, since the first target resource is an animation resource, and the animation is changing, each animation needs to be rendered frame by frame in the rendering process to obtain a plurality of rendered first rendering textures. Finally, the rendered first rendering textures are displayed on the first display region of the graphical user interface in an attachment manner, and are displayed in the game, and then a complete dynamic image is formed, which is convenient to continue processing of the display effect in the game. In addition, since the display priority of the first dynamic image is higher than the display priority of the image editing control, when the edited first dynamic image is relatively larger, partial controls in the graphical user interface may be blocked by the first dynamic image. In addition, the purpose of displaying a plurality of dynamic images of different sizes is as follows. In an actual game, for a same first dynamic image, there is a need of different display manners for the first dynamic image in different game scenes; in some game scenes, a head image needs to be displayed; in some game scenes, a half-body image needs to be displayed; and in some game scenes, a whole-body image needs to be displayed. Therefore, in the embodiment, a plurality of first dynamic images of different sizes are provided in the editor, so that developers can perform editing and development according to needs.

In the foregoing manner, the first dynamic image is rendered through the rendering logic of the rendering texture, and displayed in the first display region of the graphical user interface, which facilitates subsequent editing of the dynamic image, and improving the displayable effect simultaneously. In addition, by displaying a plurality of first dynamic image images of different sizes, rich resources to be edited are provided, thus enriching the editing result of the first dynamic image simultaneously, and further improving the development efficiency.

The image editing control includes a first cropping control. The step S104 is described below. For the step of displaying the edited target dynamic image on the preview interface in response to the first operation for the image editing control, a possible implementation is as follows.
(1) In response to a trigger operation for the first cropping control, the first dynamic image is provided on the preview interface, where the preview interface is provided with a cropping function.
(2) The preview interface is cropped according to the cropping function of the preview interface, and the cropped target dynamic image is displayed on the preview interface.

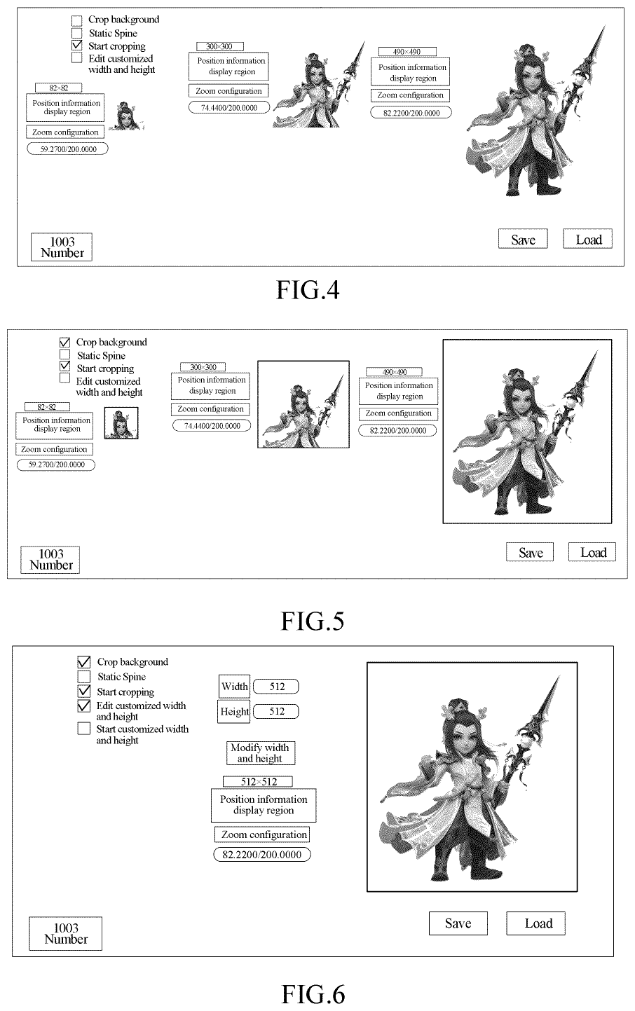

The first cropping control corresponds to “Start cropping” shown in FIG. 4, and the first dynamic image may be attached onto the preview interface in an attachment manner by clicking the selection box in front of “Start cropping”, that is, to attach the rendered first rendering texture onto the preview interface. In some embodiments, the preview interface may be cropped by using a preset size parameter, so that the cropped preview interface can only display the first dynamic image in the cropped portion, that is, the target dynamic image. As shown in FIG. 4, the displayed cropped target dynamic image may be a head image, a half-body image, and a whole-body image of the first dynamic image. In this manner, by providing the first dynamic image on the preview interface and cropping the preview interface, the cropping and editing function for the first dynamic image is realized, thus improving the editing efficiency.

In step (2), for the step of cropping the preview interface based on the cropping function of the preview interface and displaying the cropped target dynamic image on the preview interface, a possible implantation is as follow.

A cropping region is obtained by cropping the preview interface based on the cropping function of the preview interface according to the cropping size corresponding to the first dynamic image, where the first dynamic image includes a plurality of first dynamic images, and the cropping size corresponding to each first dynamic image is different from each other; and, the dynamic image within the cropping region is determined as the target dynamic image, and the target dynamic image is displayed in the cropping region.

A corresponding cropping size is provided for each first dynamic image and displayed on the graphical user interface, such as 82×82, 300×300, 490×490 shown in FIG. 4. For example, the preview interface corresponding to the first one of the first dynamic images in FIG. 3 is cropped according to the cropping size of 82×82 to obtain a cropping region in the size of 82 ×82, such as the first cropping region shown in FIG. 4; the dynamic image displayed within the cropping region is determined as the target dynamic image; and finally, the target dynamic image is displayed in the cropping region. As shown in FIG. 4, three cropping regions may be finally obtained, and a corresponding target dynamic image is displayed in each cropping region. In this manner, the preview interface is cropped according to the cropping size corresponding to each first dynamic image, and the target dynamic image is displayed in the cropping region, so that the editing efficiency and the development efficiency are further improved.

As shown in FIG. 4, the graphical user interface further includes a zoom control corresponding to the “59.2700/200.0000” control below “Zoom configuration” in FIG. 4; and after the step of determining the dynamic image within the cropping region as the target dynamic image and displaying the target dynamic image in the cropping region, the method further includes: in response to a second operation for the zoom control, adjusting a size of the first dynamic image according to a zoom parameter displayed by the zoom control; and displaying the dynamic image displayed in the cropping region based on the size-adjusted first dynamic image. In some embodiments, the editor may control the mouse to click or move the zoom control after clicking, and select a zoom parameter; where, if the zoom parameter displayed by the zoom control is greater than “59.27” displayed initially, the size of the first dynamic image is zoomed in and according to the displayed zoom parameter; and if the zoom parameter displayed by the zoom control is less than “59.27” displayed initially, the size of the first dynamic image is zoomed out and according to the displayed zoom parameter. In some embodiments, after the first dynamic image is adjusted, the target dynamic image displayed in the cropping region may be adjusted as well. In some embodiments, since the cropping region is unchanged, after the size of the first dynamic image is adjusted, the image displayed in the cropping region may be necessarily changed. In this manner, the first dynamic image is zoomed and edited by controlling and displaying the zoom parameter in real time, thus further improving the editing effect and the development effect.

In some embodiments, after the step of determining the dynamic image within the cropping region as the target dynamic image and displaying the target dynamic image in the cropping region, the method further includes: in response to a position adjustment operation for the target dynamic image displayed in the cropping region, controlling the first dynamic image to move, and displaying position information of the moved first dynamic image; and adjusting the dynamic image displayed in the cropping region based on the moved first dynamic image.

With continued reference to “Position information display region” shown in FIG. 4, during actual implementation, the user may control the mouse to perform a clicking and moving operation on the target dynamic image displayed in each cropping region, to control the first dynamic image to move, and display the position information of the moved first dynamic image, for example, X: 27, Y:−219, or the like. At the same time, the moved first dynamic image within the cropping region is determined as the target dynamic image, and the target dynamic image is displayed. In this manner, the first dynamic image may be controlled to move, the position of the first dynamic image may be adjusted, and the position information may be displayed, thus further improving the editing effect and the development effect.

The image editing control further includes a second cropping control and a third cropping control. As shown in FIG. 4, the second cropping control corresponds to “Crop background” in the figure and the third cropping control corresponds to “Edit customized width and height” in the figure. After the step of determining the dynamic image within the cropping region as the target dynamic image and displaying the target dynamic image in the cropping region, the method further includes:
(1) in response to a trigger operation for the second cropping control, identifying and displaying a cropping region;
(2) in response to a trigger operation for the third cropping control, displaying an editing interface corresponding to a target cropping region, where the editing interface includes a parameter editing control and a determination control; and
(3) adjusting the size of the cropping region based on the parameter editing control and the determination control.

The manner of identifying and displaying may be highlighting, or displaying in other manners, the purpose of which is to display the cropping region in an outstanding manner. In some embodiments, the editor may click the selection box for “Crop background” to highlight each cropping region. As shown in FIG. 5, the manner of identifying and displaying is represented as displaying with a black frame. Then, by clicking the selection box for “Edit customized width and height”, an editing interface corresponding to the target cropping region is displayed, where the target cropping region generally refers to a cropping region with the largest cropping size. As shown in FIG. 6, the editing interface includes a parameter editing control and a determination control, where “Modify width and height” in FIG. 6 corresponds to the above determination control, and the parameter editing control includes cropping size input controls for “Width” and “Height”. During actual implementation, the width and height that need to be modified may be edited in the parameter editing controls, then the size of the cropping region may be adjusted by clicking “Modify width and height”, and the modified cropping region may be displayed. Finally, if “Start customized width and height” in the figure is clicked, the modified cropping size may be applied to the graphical user interface.

In the foregoing manner, the size of the cropping region may be customized and adjusted by using the second cropping control and the third cropping control, which is not limited to a preset cropping size, thus improving flexibility of dynamic image editing.

For the step of adjusting the size of the cropping region based on the parameter editing control and the determination control, a possible implementation is: in response to an editing operation for the parameter editing control, determining a size parameter corresponding to the editing operation; and in response to a trigger operation for determination control, updating the size of the target cropping region according to the size parameter, and identifying and displaying the updated cropping region.

In some embodiments, the editor may input the cropping size desired to be modified in the input boxes corresponding to the “Width” and “Height” shown in FIG. 6; after the input is completed, the size parameter corresponding to the editing operation may be determined by clicking “Modify width and height” below; then, the size of the target cropping region may be updated and displayed on the editing interface by clicking the determination control, i.e., “Modify width and height” in FIG. 6; and, the updated cropping region may also be identified and displayed. Finally, if “Start customized width and height” in the figure is clicked, the modified cropping size may be applied to the graphical user interface. In some embodiments, if selection of the second cropping control is directly cancelled, the display editing interface is cancelled.

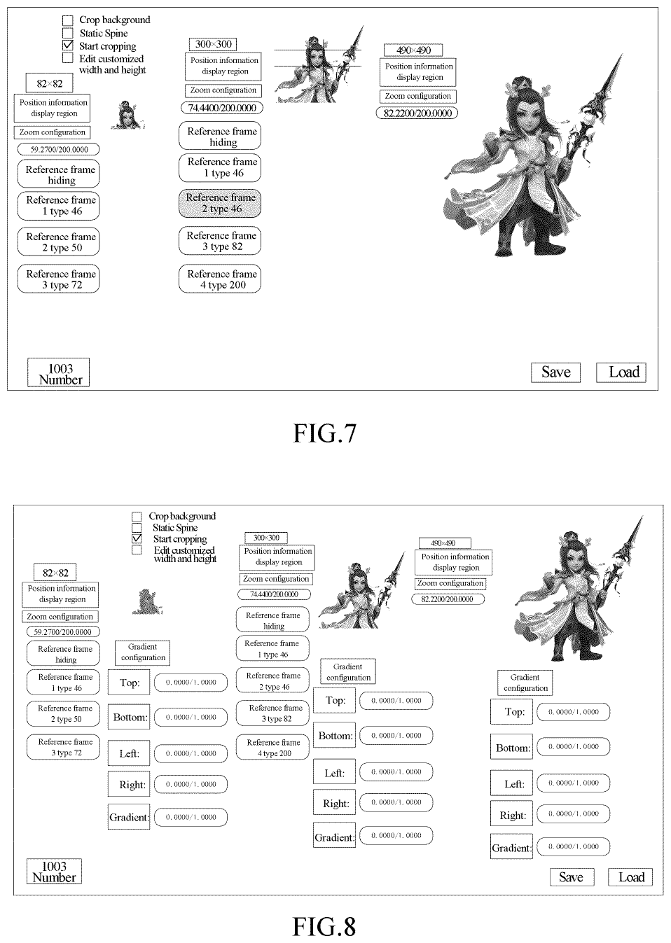

Since the editor may move the position of the first dynamic image in the cropping region, in order to further improve the display effect of the target dynamic image within the cropping region, the graphical user interface further includes a reference frame control and a reference frame hiding control, where the reference frame control generally includes a plurality of reference frame controls. As shown in FIG. 7, the first cropping region may display three reference frame controls, “Reference frame 1 type 46”, “Reference frame 2 type 50”, and “Reference frame 3 type 72”. The second cropping region may display four reference frame controls, “Reference frame 1 type 64”, “Reference frame 2 type 64”, “Reference frame 3 type 82”, and “Reference frame 4 type 200”. The size of the reference frame correspondingly displayed by each reference frame control is different from each other. In some embodiments, the sizes of the reference frames correspondingly displayed by the reference frame controls in the cropping regions of different sizes are also different from each other.

It should be noted that only the head image and the half-body image need the reference frames. The function of the reference frame is to divide out the central region in the head image and the half-body image, so that the editor can align and place the main content (such as the face of the character) region of the image in the central region more conveniently, which is more artistic. However, for the size of the whole-body image, it does not need a reference frame because the entire content may be displayed.

After the step of determining the dynamic image within the cropping region as the target dynamic image and displaying the target dynamic image in the cropping region, the method further includes: in response to a trigger operation for the reference frame control, displaying a reference frame corresponding to the reference frame control at a preset position in the cropping region; and, in response to a trigger operation for the reference frame hiding control, cancelling display of the reference frame.

As shown in FIG. 7, the editor may click “Reference frame 2 type 64”, and a reference frame as in the figure may be displayed in a cropping region displayed in the middle, where the reference frame is mainly used to indicate to adjust the position of the first dynamic image in the cropping region. If the position of the first dynamic image in the cropping region needs to be adjusted, the reference frame may be used as a reference for adjustment; for example, the head portion of the image may be adjusted to the middle of the reference frame. After the adjustment of the position of first dynamic image position is completed, the reference frame hiding control may be clicked to cancel the display of the reference frame. In the foregoing manner, by displaying a reference frame in the cropping region, it is beneficial for the editor to adjust the position of the first dynamic image, thus improving the editing efficiency and the effect of the dynamic image.

Since the effect is poor by using the Spine tool to directly perform edge gradient, in order to present a better gradient effect, the graphical user interface further includes a gradient parameter configuration control, where the gradient parameter configuration control is used to adjust the transparency of the edge of the target dynamic image displayed in the cropping region, so that the edge region of the target dynamic image is provided with a gradient effect. After the step of displaying the edited target dynamic image on the preview interface in response to the first operation for the image editing control, the method further includes: in response to a third operation for the gradient parameter configuration control, adjusting a transparency of an edge region of the target dynamic image.

The third operation may be a click operation, or may be a click moving operation, or the like. The gradient parameter configuration control generally includes a plurality of gradient parameter configuration controls, and each gradient parameter configuration control is configured to control a transparency of an edge region of the target dynamic image in a specified direction. For example, the top gradient parameter configuration control is configured to control the transparency of the top edge region of the target dynamic image, where the transparency is in a gradient manner, and provided with a gradient display effect. In this manner, through the gradient parameter configuration control, the transparency of the edge region of the target dynamic image may be controlled and adjusted, thus achieving the display effect of gradient transparency, and improving the effect of the target dynamic image.

The gradient parameter configuration controls include a plurality of first gradient parameter configuration controls. For example, “Top: 0.0000/1.0000”, “Bottom: 0.0000/1.0000”, “Left: 0.0000/1.0000”, and “Right: 0.0000/1.0000” shown in FIG. 8 correspond to the first gradient parameter configuration controls. For the step of adjusting the transparency of the edge region of the target dynamic image in response to the third operation for the gradient parameter configuration control, a possible implementation is as follows.

In step 1, in response to a selection operation for a first parameter of a first gradient parameter configuration control, a first edge region of the target dynamic image is determined according to the first parameter, where the first parameter is used to indicate a direction and a range of the first edge region.

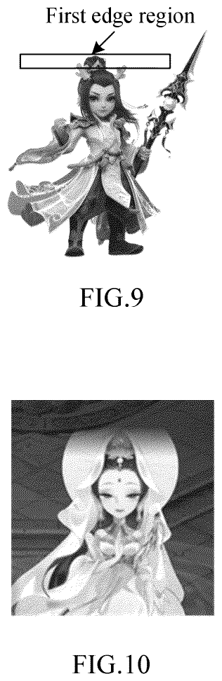

During actual implementation, referring to the gradient parameter configuration control displayed in the cropping region in the middle of FIG. 8, “Top: 0.0000/1.0000” may be clicked to select the first parameter as 0.2000, where the first parameter is used to indicate a percentage region from the top edge of the target dynamic image to the bottom edge of the target dynamic image; that is, 0.2000 indicates that 20% of the region from the top edge of the target dynamic image to the bottom edge of the target dynamic image is the first edge region, a schematic diagram of which is as shown in FIG. 9. In some embodiments, if the first parameter is 0.0000, it indicates that there is no first edge region; and if the first parameter is 1.0000, it indicates that the region from the top edge of the target dynamic image to the bottom edge of the target dynamic image is the first edge region. Similarly, if “Bottom: 0.0000/1.0000”, “Left: 0.0000/1.0000”, or “Right: 0.0000/1.0000” is clicked to select the first parameter, a corresponding first edge region may also be determined.

In step 2, the transparency of the first edge region is adjusted.

In some embodiments, the transparency of the first edge region may be directly adjusted directly according to a preset parameter. For example, the transparency of the first edge region may be adjusted directly according to a rule that the transparency gradually decreases from the edge to the center, so that the first edge region is provided with an effect that the transparency gradually decreases from the edge to the center.

A region needing to be adjusted may also be determined from the first edge region, and transparency adjustment may be performed in the region according to a preset adjustment manner. For example, it is determined from the first edge region that only 50% of the edge region needs transparency adjustment. That is, the transparency adjustment is performed from the top edge of the first edge region to the middle position of the first edge region, so that it is provided with an effect that the transparency gradually decreased from the top edge of the first edge region to the middle position of the first edge region.

In the foregoing manner, the first parameter is selected through the first gradient parameter configuration control, the first edge region needing to be displayed with a gradient effect is determined, and then the transparency of the first edge region is adjusted, so that the edge of the target dynamic image can be provided with a gradient effect, thus improving the display effect of the dynamic image.

The gradient parameter configuration control includes a second gradient parameter configuration control, and the second gradient parameter configuration control corresponds to “Gradient: 0.0000/1.0000” as shown in FIG. 8. For the step (2) of adjusting the transparency of the first edge region, a possible implementation is as follows.

In step 21, in response to a selection operation for a second parameter of the second gradient parameter configuration control, a second edge region is determined from the first edge region according to the second parameter, where the second parameter is used to indicate a range of the second edge region, and the second edge region is less than or equal to the first edge region. In step 22, a transparency of the second edge region is adjusted, where a transparency value of a region closer to an edge of the second edge region is higher, and a transparency value of a region farther from the edge of the second edge region is lower.

For example, if the first edge region is a top edge region, the second parameter is used to indicate a range of a region from a top position to a target position in the middle region of the first edge region. For example, if the second parameter is 0.0000, the second edge region may not be determined, and the gradient effect may not be displayed. If the second parameter is 1.0000, the first edge region is directly determined as the second edge region. If the second parameter is 0.5000, the region from the top position to the middle position (i.e., the position of 50%) of the first edge region is determined as the second edge region.

Then, the transparency value of the top edge of the second edge region is adjusted to be higher, and the transparency value of the bottom edge of the second edge region is adjusted to be lower. For example, as shown in FIG. 10, it shows the gradient effect of the second edge region when the first parameter for the top displayed in the middle cropping region is 0.2000 and the second parameter is 0.5000. In the foregoing manner, the second parameter is selected according to the second gradient parameter configuration control, the second edge region is determined through the second parameter, the transparency is adjusted in the second edge region to achieve the gradient effect of the second edge region, thus further improving the effect of the dynamic image.

For different cropping sizes, it may need to partially display the image. For example, for a half-image size, it may cut off the whole-body image, and it is undesired to leave a hard edge when cropping the edge. In some related art, the edge gradient effect is directly performed through Spine, however, the effect is poor. In order to present a better gradient effect, in step 22, for the step of adjusting the transparency of the second edge region, a possible implementation is as follows.

In step 221, a preset gradient material is obtained.

In step 222, the gradient material is assigned to the first dynamic image through a preset rendering interface.

In step 223, a transparency value corresponding to a pixel point of the second edge region is adjusted through the gradient material, to enable the adjusted second edge region to be provided with a transparency gradient effect.

A Spine-to-RT module is encapsulated in the editor, which may be represented as CSpine2ImageRTLayout. During actual implementation, a post-processing material ui_spine_alpha_rt for the edge gradient is pre-made, i.e., the above gradient material. The gradient material may be applied to the first dynamic image through a rendering interface (such as GLProgram) preset in the game engine, and then the dynamic image rendered thereon may be processed. According to the position information of a pixel point of the second edge region, the transparency value corresponding to the pixel point may be adjusted through the gradient material, to enable the adjusted second edge region to be provided with a transparency gradient effect. In some embodiments, GLProgram is encapsulated with a set of logics for interaction with the bottom rendering interface (D3D or OpenGL), and the rendering logic may be modified from the Shader level, which facilitates the customization of various special effects on the interface control in the game. In the foregoing manner, by assigning the first dynamic image with a gradient material, the gradient effect of the second edge region is achieved, the operation mode is simple, and meanwhile, the gradient effect of the second edge region is improved.

In order to further improve the effect of the second edge region, in step 223, for the step of adjusting the transparency value corresponding to the pixel point of the second edge region through the gradient material, a possible implementation is: sampling UV coordinates of a target pixel point of the second edge region through a shader for the gradient material; determining a distance value between the target pixel point and an edge pixel point of the second edge region according to the UV coordinates of the target pixel point; determining a target transparency value corresponding to the target pixel point according to the distance value and a preset control parameter; and adjusting a transparency value corresponding to the target pixel point of the second edge region to the target transparency value.

In the shader for the gradient material, a gradient adjustment rule is preset. In some embodiments, if the second edge region is the top edge region, the UV coordinates of each pixel point of the second edge region are sampled. For each pixel point, the distance value between the pixel point and the top position pixel point of the second edge region is determined according to the UV coordinates of the pixel point. The preset control parameter may be transparency values corresponding to different distance values. The specific correspondence is: the smaller the distance value is, the greater the corresponding transparency value is; and the greater the distance value is, the smaller the corresponding transparency value is. In some embodiments, in the preset control parameter, the size of the distance value usually needs to be determined according to the range value of the second edge region. When the distance value is 0, the corresponding maximum transparency value is 1. When the distance value is the maximum range value of the second edge region, the corresponding minimum transparency value is 0. It may be understood that the distance value and transparency value may be determined according to a linear function y=−ax+1, where x is the distance value, and y is the transparency value. As the distance value increases or decreases, the transparency gradually decreases or increases.

For example, if the minimum distance value between the pixel point and the top position pixel point of the second edge region is 0, the transparency value of the corresponding pixel point is 1; if the maximum distance value between the pixel point and the top position pixel point of the second edge region is 1, the transparency value of the corresponding pixel point is 0; and if the distance value between the pixel point and the top position pixel point of the second edge region is 0.1, the transparency value of the corresponding pixel point is 0.9.

In the foregoing manner, the transparency value of the pixel point is adjusted based on the distance value between the pixel point and the edge pixel point of the second edge region through the shader for the gradient material, so that the gradient effect of the second edge region is further improved.

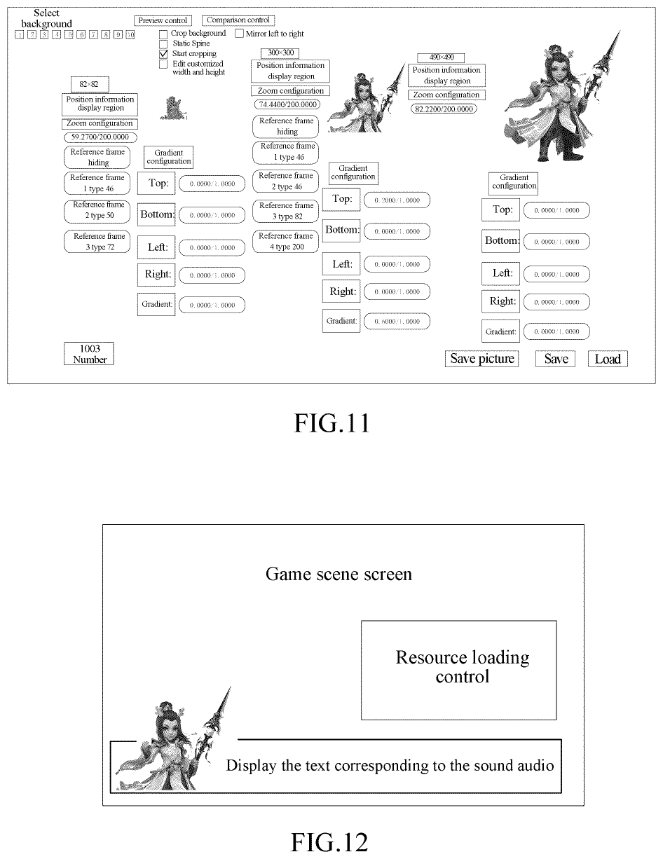

When these resources are used in some special cases (such as in some low-configuration devices), if the dynamic image saved by the editor is loaded and displayed, the consumption may be relatively higher. Based on this, the graphical user interface further includes a static control and a picture saving control. As shown in FIG. 11, the static control corresponds to “Static Spine” in FIG. 11, and the picture saving control corresponds to “Save picture” in FIG. 11. After the step of displaying the edited target dynamic image on the preview interface in response to the first operation for the image editing control, the method further includes:

in response to a trigger operation for the static control, obtaining a second target rendering texture by creating a second rendering texture and rendering an initial frame of the target dynamic image to the second rendering texture; determining the second target rendering texture as an initial frame picture; and in response to a trigger operation for the picture saving control, saving the initial frame picture.

In the embodiment, the editor also provides a function of saving the dynamic image into a static image. In some embodiments, the editor may click a selection box for “Static Spine”, and a second rendering texture is firstly created, which may be represented as Render Texture. Then, the second target rendering texture may be obtained by rendering the initial frame of the target dynamic image to the second rendering texture. The second target rendering texture is determined as the initial frame picture, and is displayed on the graphical user interface. Finally, the editor may click “Save picture”, and the initial frame picture may be output to a specified configuration file. In this manner, by creating the second rendering texture, the static image of the target dynamic image may be saved. Since less resources are occupied by the static image resource, the static image can be used in a low-configuration device to reduce the operating pressure of the device.

The graphical user interface further includes a plurality of game background display controls. As shown in FIG. 11, the game background display controls correspond to “1” to “10” in FIG. 11. The method further includes: in response to a trigger operation for a first game background display control in the plurality of game background display controls, displaying a screen of a first game background corresponding to the first game background display control in a background region of the graphical user interface.

For the ten game background display controls as shown in FIG. 11, each game background display control corresponds to a game scene screen. During actual implementation, in the process of editing the first dynamic image, or before the first target resource is loaded, the game background display control may be clicked to display the game background screen to be previewed, so that the dynamic image displayed after the resource is loaded is more intuitively fused into the game scene, thus achieving the effect of previewing the final screen in real time. The graphical user interface further includes a mirror control. As shown in FIG. 11, the mirror control corresponds to “Mirror left to right” in FIG. 11. After the step of rendering and displaying the first dynamic image corresponding to the first target resource on the graphical user interface based on the first rendering texture in response to the loading operation for the first target resource, the method further includes: in response to a trigger operation for the mirror control, obtaining a mirror image of the first dynamic image by flipping the first dynamic image; and displaying the mirror image of the first dynamic image.

The editor may select whether to perform a flip operation according to actual needs, so as to save the mirror image. During actual implementation, if needing to view the flipped image of the first dynamic image, the editor may click “Mirror left to right”. Then, the first dynamic image may be flipped, and the mirror image of the first dynamic image may be displayed at the same time. In other words, the rendered first rendered texture is flipped. The mirror function is usually used in a scenario editor dialog. In this manner, the dynamic character left-right mirror animation is supported, and the first dynamic image may be flipped to display the mirror image, thus further enriching the editing function.

In order to simulate and preview the performance and display effect of the target dynamic image in the game scene, as shown in FIG. 11, the graphical user interface further includes a preview control, and the method further includes the following.
(1) In response to a trigger operation for the preview control, a game interface is displayed on a graphical user interface, where the game interface includes a resource loading control and a game scene screen.

The editor may click the preview control. Then, a game interface may be displayed in above the graphical user interface. As shown in FIG. 12, the game interface includes a resource loading control and a game scene screen displayed as a background. In some embodiments, the resource loading control includes an input control for a dynamic image number and a loading control, which correspond to “Image ID” and “Load” in FIG. 12.
(2) In response to a fourth operation for the resource loading control, the second target resource corresponding to the fourth operation and the audio data corresponding to the second target resource are loaded, and the second dynamic image corresponding to the second target resource is displayed on the game interface.

The editor may input the number of the dynamic image to be previewed in the input control, and click “Load”, so as to load the second target resource corresponding to the number and the audio data corresponding to the second target resource. In some embodiments, the second target resource refers to an animation resource that has been edited and saved, and the audio data corresponding to the second target resource is the audio data generated in advance through an AI voice generation tool. In some embodiments, the editor may load the audio data corresponding to the second target resource from the AI voice generation tool through a preset obtaining interface, and display the second dynamic image corresponding to the second target resource on the game interface.

(3) An action screen and a sound audio corresponding to the second dynamic image are played based on the second target resource and the audio data.

The action screen corresponding to the second dynamic image not only includes an animation of a body part, but also includes a mouth shape animation. The mouth shape animation is made in advance in the Spine tool, and usually refers to a vowel mouth shape animation. For example, five vowel mouth shape animation frames of the character are made by using the Spine tool, and stored into the second target resource. In some embodiments, the action screen and the sound audio corresponding to the second dynamic image are played on the preview interface, where the sound audio needs to correspond to the mouth shape animation. For example, when the sound audio is played, the mouth shape animation is played at the same time; and when the playing of the sound audio is stopped, the playing of the mouth shape animation is stopped at the same time. The animation of the body part of the second dynamic image is generally played all the time. Meanwhile, the text corresponding to the played sound audio is synchronously displayed.

In the foregoing manner, an interface may be displayed through the preview control, and the performance and display effect of the target dynamic image in the game scene may be simulated and previewed in the preview interface, thus further improving the editing function and improving the effect of the dynamic image simultaneously.

In step (3), the second target resource includes a plurality of pre-generated mouth shape animations. For the step of playing the action screen and the sound audio corresponding to the second dynamic image based on the second target resource and the audio data, a possible implementation is: obtaining a corresponding sound audio by parsing the audio data; determining a target mouth shape animation corresponding to each target audio in the sound audio from the plurality of mouth shape animations; and playing the action screen and the sound audio corresponding to the second dynamic image, and playing the target mouth shape animation corresponding to each target audio simultaneously.

In some embodiments, through the preset AI voice analysis tool, the audio data may be converted into the sound audio that can be analyzed. Then, the target mouth shape animation of each frame of target audio on the corresponding voice time line may be determined from the plurality of mouth shape animations. Finally, during playing, the effect of synchronizing the mouth shape and the sound in the final animation representation can be achieved. In this manner, by parsing the audio data and determining the target mouth shape animation corresponding to each target audio in the sound audio, it not only realizes the real-time preview of the dynamic performance effect of the dynamic image in the game scene, but also realizes the synchronous speaking effect of the voice and the action.

In order to save the workload of resource development and reduce the total packet amounts of the saved dynamic resources, as shown in FIG. 11, the graphical user interface further includes a comparison control, and the method further include the following.

(1) In response to a trigger operation for the comparison control, a comparison interface is displayed on the graphical user interface, where the comparison interface includes a plurality of resource input controls, each resource input control is provided with a corresponding image display region and a loading control, and the resource input control is configured for input of a resource number of a target resource.

The editor may click the comparison control, and then the comparison interface may be displayed on the graphical user interface. As shown in FIG. 13, the comparison interface includes a plurality of resource input controls (for example, 8 resource input controls shown in FIG. 13), where number input boxes are included. A corresponding image display region is displayed above each resource input control for displaying a dynamic image corresponding to the number. In addition, a loading control is further included in FIG. 13.

(2) In response to a trigger operation for the loading control corresponding to the target resource input control, a third target resource corresponding to a resource number displayed by the target resource input control is loaded.

(3) A third dynamic image corresponding to the third target source is displayed in an image display region corresponding to the target resource input control.

The editor may input a resource number of the third target resource desired to be compared in each resource input control. If eight are desired to be compared, the resource number may be input in each resource input control, and “Load” may be clicked after completion of input. Then, the third target resources corresponding to the resource numbers may be loaded, and the target dynamic images in the third target resources may be displayed in the image display region, as shown in FIG. 13. In this manner, by simultaneously displaying the plurality of target dynamic images, the sizes and display effects of the plurality of target dynamic images may be compared, thus facilitating the editor to unify the specifications, so that each displayed target dynamic image has a unified display and style effect. Meanwhile, editing is performed in a unified comparison manner, so that the development efficiency is further improved. At the same time, the subsequent unified specification is performed in a comparison manner, so that the total packet amounts of the resource is also reduced.

The comparison interface further includes a plurality of selection controls, and each selection control corresponds to an image size. As shown in FIG. 13, the selection control includes three selection controls, which are “Head image”, “Half-body image” and “Whole-body image”, respectively. The method further includes: in response to a trigger operation for a first selection control in the plurality of selection controls, displaying a third dynamic image of a first image size corresponding to the first selection control in the image display region.

In some embodiments, before each target dynamic image is loaded, the first selection control in the plurality of selection controls may be clicked, and then the size of the displayed third dynamic image is the size corresponding to the first selection control. For example, if “Half-body image” is clicked, each displayed third dynamic image is a half-body image. In some embodiments, after each third dynamic image is loaded, the first selection control in the plurality of selection controls may be clicked, and the image size of the displayed third dynamic images may be uniformly. For example, if “Half-body image” is clicked, the displayed third dynamic images may be uniformly as half-body images. In this manner, the image size of the displayed third dynamic image may be uniformly through the selection control, which further improves the editing efficiency and the comparison efficiency, and improves the development efficiency simultaneously.

As shown in FIG. 13, the comparison interface further includes a reference line control, and the method further includes: in response to a trigger operation for the reference line control, displaying a reference line corresponding to the reference line control on the comparison interface.

The reference line may facilitate the editor to compare whether the position of each displayed third dynamic image displayed is correct, and to quickly find out the position of which image is different from the positions of other images based on comparison. Visual comparison is intuitively performed through reference lines, which further improves editing efficiency and comparison efficiency, and improves development efficiency simultaneously.

As shown in FIG. 13, the comparison interface further includes a static image control, and the method further includes: in response to a trigger operation for the static image control, displaying an initial frame picture of the third dynamic image in the image display region.

Since the static image is also an important resource in game development, the comparison interface further includes a static image control. The editor may click the static image control, and the initial frame picture of the third dynamic image may be displayed, for the convenience of the editor to compare the static images.

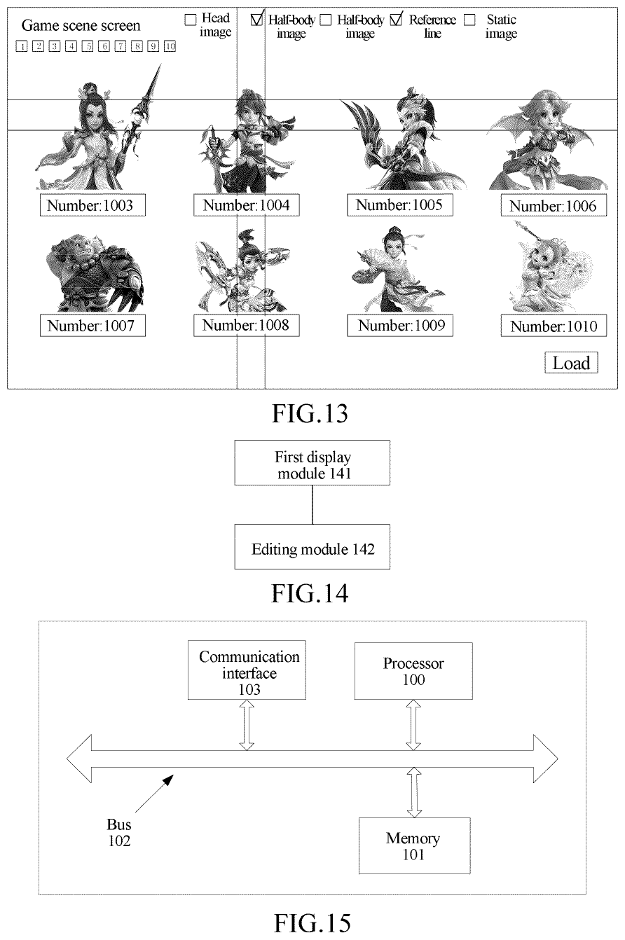

Corresponding to the foregoing method embodiments, there is provided an apparatus for dynamic image editing according to embodiments of the present disclosure, where a graphical user interface is provided by a terminal device, and the graphical user interface includes an image editing control. As shown in FIG. 14, the apparatus includes a first display module 141 and an editing module 142.

The first display module 141 is configured to, in response to a loading operation for a first target resource, render and display a first dynamic image corresponding to the first target resource in the graphical user interface based on a first rendering texture.

The editing module 142 is configured to, in response to a first operation for the image editing control, display an edited target dynamic image on a preview interface.

According to the apparatus for dynamic image editing provided by the embodiments of the present disclosure, in response to a loading operation for a first target resource, a first dynamic image corresponding to the first target resource is rendered and displayed in the graphical user interface based on a first rendering texture; and in response to a first operation for an image editing control in the graphical user interface, an edited target dynamic image is displayed on a preview interface. In this manner, the dynamic image may be directly edited based on the preview interface, the display effect of the edited dynamic image may be viewed in real time through the rendering texture, and the saved result may be directly applied to the game, thus avoiding the problem that the dynamic image needs to be developed in a plurality of software, simplifying the development process of the game, reducing the labor cost and the time cost, and improving the development efficiency.

In some embodiments, the first display module is further configured to: load the first target resource; obtain a first target rendering texture by creating the first rendering texture and rendering the first target resource to the first rendering texture frame by frame; and determine the first target rendering texture as the first dynamic image, and display the first dynamic image in a first display region of the graphical user interface; where a display priority of the first dynamic image is higher than a display priority of the image editing control, the first dynamic image includes a plurality of first dynamic images, and a size of each first dynamic image is different from each other.

In some embodiments, the image editing control includes a first cropping control; the editing module is further configured to: in response to a trigger operation for the first cropping control, provide the first dynamic image on the preview interface, where the preview interface is provided with a cropping function; and, crop the preview interface according to the cropping function of the preview interface, and display a cropped target dynamic image.

In some embodiments, the editing module is further configured to: obtain a cropping region by cropping the preview interface according to a cropping size corresponding to the first dynamic image based on the cropping function of the preview interface, where the first dynamic image includes a plurality of first dynamic images, and a cropping size corresponding to each first dynamic image is different from each other; and determine a dynamic image within the cropping region as the target dynamic image, and display the target dynamic image in the cropping region.

In some embodiments, the graphical user interface further includes a zoom control, and the apparatus further includes a first adjustment module configured to: in response to a second operation for the zoom control, adjust a size of the first dynamic image according to a zoom parameter displayed by the zoom control; and adjust a dynamic image displayed in the cropping region based on the size-adjusted first dynamic image.

In some embodiments, the apparatus further includes a second adjustment module configured to: in response to a position adjustment operation for the target dynamic image displayed in the cropping region, control the first dynamic image to move, and display position information of the moved first dynamic image; and adjust the dynamic image displayed in the cropping region based on the moved first dynamic image.

In some embodiments, the image editing control further includes a second cropping control and a third cropping control, and the apparatus further includes a cropping module configured to: in response to a trigger operation for the second cropping control, identify and display the cropping region; in response to a trigger operation for the third cropping control, display an editing interface corresponding to a target cropping region, where the editing interface includes a parameter editing control and a determination control; and, adjust a size of the cropping region based on the parameter editing control and the determination control.

In some embodiments, the cropping module is further configured to: in response to an editing operation for the parameter editing control, determine a size parameter corresponding to the editing operation; and in response to a trigger operation for determining the control, update a size of the target cropping region according to the size parameter, identify and display the updated cropping region.

In some embodiments, the graphical user interface further includes a reference frame control and a reference frame hiding control. The apparatus further includes a second display module configured to: in response to a trigger operation for the reference frame control, display a reference frame corresponding to the reference frame control at a preset position in the cropping region; and in response to a trigger operation for the reference frame hiding control, cancel display of the reference frame.

In some embodiments, the graphical user interface further includes a gradient parameter configuration control, and the apparatus further includes a third adjustment module configured to adjust a transparency of an edge region of the target dynamic image in response to a third operation for the gradient parameter configuration control.

In some embodiments, the gradient parameter configuration control includes a plurality of first gradient parameter configuration controls, and the third adjustment module is further configured to: in response to a selection operation for a first parameter of the first gradient parameter configuration control, determine a first edge region of the target dynamic image according to the first parameter, where the first parameter is used to indicate a direction and a range of the first edge region; and adjust a transparency of the first edge region.

In some embodiments, the gradient parameter configuration control includes a second gradient parameter configuration control, and the third adjustment module is further configured to: in response to a selection operation for a second parameter of the second gradient parameter configuration control, determine a second edge region from the first edge region according to the second parameter, where the second parameter is used to indicate a range of the second edge region, and the second edge region is less than or equal to the first edge region; and adjust a transparency of the second edge region, where a transparency value of a region closer to an edge of the second edge region is higher, and a transparency value of a region farther from the edge of the second edge region is lower.

In some embodiments, the third adjustment module is further configured to: obtain a preset gradient material; assign the gradient material to the first dynamic image through a preset rendering interface; and adjust a transparency value corresponding to a pixel point of the second edge region through the gradient material, to enable the adjusted second edge region to be provided with a transparency gradient effect.

In some embodiments, the third adjustment module is further configured to: sample UV coordinates of a target pixel point of the second edge region through a shader for the gradient material; determine a distance value between the target pixel point and an edge pixel point of the second edge region according to the UV coordinates of the target pixel point; determine a target transparency value corresponding to the target pixel point according to the distance value and a preset control parameter; and adjust a transparency value corresponding to the target pixel point of the second edge region to the target transparency value.

In some embodiments, the graphical user interface further includes a static control and a picture saving control, and the apparatus further includes a second saving module configured to: in response to a trigger operation for the static control, obtain a second target rendering texture by creating a second rendering texture and rendering an initial frame of the target dynamic image to the second rendering texture; determine the second target rendering texture as an initial frame picture; and save the initial frame picture in response to a trigger operation for the picture saving control.

In some embodiments, the graphical user interface further includes a plurality of game background display controls, and the apparatus further includes a third display module configured to: in response to a trigger operation for a first game background display control in the plurality of game background display controls, display a screen of a first game background corresponding to the first game background display control in a background region of the graphical user interface.

In some embodiments, the graphical user interface further includes a mirror control, and the apparatus further includes a mirror module configured to: in response to a trigger operation for the mirror control, obtain a mirror image of the first dynamic image by flipping the first dynamic image; and display the mirror image of the first dynamic image.

In some embodiments, the graphical user interface further includes a preview control, and the apparatus further includes a preview module configured to: in response to a trigger operation for the preview control, display a game interface on the graphical user interface, where the game interface includes a resource loading control and a game scene screen; in response to a fourth operation for the resource loading control, load a second target resource corresponding to the fourth operation and audio data corresponding to the second target resource, and display a second dynamic image corresponding to the second target resource on the game interface; and paly an action screen and a sound audio corresponding to the second dynamic image based on the second target resource and the audio data.

In some embodiments, the second target resource includes a plurality of pre-generated mouth shape animations, and the preview module is further configured to: obtain a corresponding sound audio by parsing the audio data; determine a target mouth shape animation corresponding to each target audio in the sound audio from the plurality of mouth shape animations; and, play the action screen and the sound audio corresponding to the second dynamic image, and play the target mouth shape animation corresponding to each target audio simultaneously.

In some embodiments, the graphical user interface further includes a comparison control, and the apparatus further includes a comparison module configured to: in response to a trigger operation for the comparison control, display a comparison interface on the graphical user interface, where the comparison interface includes a plurality of resource input controls, and each resource input control is provided with a corresponding image display region and a loading control, and the resource input control is used for input of a resource number of a target resource; in response to a trigger operation for the loading control corresponding to the target resource input control, load a third target resource corresponding to a resource number displayed by the target resource input control; and display a third dynamic image corresponding to the third target source in an image display region corresponding to the target resource input control.

In some embodiments, the comparison interface further includes a plurality of selection controls, each selection control corresponds to an image size, and the comparison module is further configured to: in response to a trigger operation for a first selection control in the plurality of selection controls, display a third dynamic image of a first image size corresponding to the first selection control in the image display region.

In some embodiments, the comparison interface further includes a reference line control, and the comparison module is further configured to: in response to a trigger operation for the reference line control, display a reference line corresponding to the reference line control on the comparison interface.

In some embodiments, the comparison interface further includes a static image control, and the comparison module is further configured to: in response to a trigger operation for the static image control, display an initial frame picture of the third dynamic image in the image display region.

In some embodiments, the apparatus further includes a first saving module configured to: in response to a saving operation for the target dynamic image, convert data information corresponding to the target dynamic image into a target code, and save the target code in a preset configuration file.

The apparatus for dynamic image editing provided by the embodiments of the present disclosure has the same technical features as the method for dynamic image editing provided by the above embodiments, which can also solve the same technical problems and achieve the same technical effects.

According to the embodiment, there is further provided an electronic device, including a processor and a memory. The memory stores a computer-executable instruction executable by the processor, and the processor executes the computer-executable instruction to implement the method for dynamic image editing. The electronic device may be a server, or may be a terminal device.

Referring to FIG. 15, the electronic device includes a processor 100 and a memory 101, where the memory 101 store a computer-executable instruction executable by the processor 100, and the processor 100 executes the computer-executable instruction to implement the method for dynamic image editing, In some embodiments, to implement the following the method. In response to a loading operation for a first target resource, a first dynamic image corresponding to the first target resource is rendered and displayed in the graphical user interface based on a first rendering texture; and in response to a first operation for the image editing control, an edited target dynamic image is displayed on the preview interface.

The step of rendering and displaying the first dynamic image corresponding to the first target resource in the graphical user interface based on the first rendering texture includes: loading the first target resource; obtaining a first target rendering texture by creating the first rendering texture and rendering the first target resource to the first rendering texture frame by frame; determining the first target rendering texture as the first dynamic image, and displaying the first dynamic image in a first display region of the graphical user interface; where a display priority of the first dynamic image is higher than a display priority of the image editing control, the first dynamic image includes a plurality of first dynamic images, and a size of each first dynamic image is different from each other.

The image editing control includes a first cropping control, and the step of displaying the edited target dynamic image on the preview interface in response to the first operation of the image editing control includes: in response to a trigger operation for the first cropping control, providing the first dynamic image on the preview interface, where the preview interface is provided with a cropping function; and cropping the preview interface according to the cropping function of the preview interface, and displaying a cropped target dynamic image on the preview interface.

The step of cropping the preview interface according to the cropping function of the preview interface, and displaying the cropped target dynamic image on the preview interface includes: obtaining a cropping region by cropping the preview interface according to the cropping function of the preview interface based on a cropping size corresponding to the first dynamic image, where the first dynamic image includes a plurality of first dynamic images, and a cropping size corresponding to each first dynamic image is different from each other; and determining a dynamic image within the cropping region as the target dynamic image, and displaying the target dynamic image in the cropping region.

The graphical user interface further includes a zoom control. After the step of determining the dynamic image within the cropping region as the target dynamic image and displaying the target dynamic image in the cropping region, the method further includes: in response to a second operation for the zoom control, adjusting a size of the first dynamic image according to a zoom parameter displayed by the zoom control; and adjusting the dynamic image displayed in the cropping region based on the size-adjusted first dynamic image.

After the step of determining the dynamic image within the cropping region as the target dynamic image and displaying the target dynamic image in the cropping region, the method further includes: in response to a position adjustment operation for the target dynamic image displayed in the cropping region, controlling the first dynamic image to move, and displaying position information of the moved first dynamic image; and adjusting the dynamic image displayed in the cropping region based on the moved first dynamic image.

The image editing control further includes a second cropping control and a third cropping control. After the step of determining the dynamic image within the cropping region as the target dynamic image and displaying the target dynamic image in the cropping region, the method further includes: in response to a trigger operation for the second cropping control, identifying and displaying the cropping region; in response to a trigger operation for the third cropping control, displaying an editing interface corresponding to a target cropping region, where the editing interface includes a parameter editing control and a determination control; and adjusting a size of the cropping region based on the parameter editing control and the determination control.

The step of adjusting the size of the cropping region based on the parameter editing control and the determination control includes: in response to an editing operation for the parameter editing control, determining a size parameter corresponding to the editing operation; and in response to a triggering operation for the determination control, updating a size of the target cropping region according to the size parameter, identifying and displaying the updated cropping region. The graphical user interface further includes a reference frame control and a reference frame hiding control. After the step of determining the dynamic image within the cropping region as the target dynamic image and displaying the target dynamic image in the cropping region, the method further includes: in response to a trigger operation for the reference frame control, displaying a reference frame corresponding to the reference frame control at a preset position in the cropping region; and in response to a trigger operation for the reference frame hiding control, cancelling display of the reference frame.

The graphical user interface further includes a gradient parameter configuration control. After the step of displaying the edited target dynamic image on the preview interface in response to the first operation for the image editing control, the method further includes: in response to a third operation for the gradient parameter configuration control, adjusting a transparency of an edge region of the target dynamic image.

The gradient parameter configuration control includes a plurality of first gradient parameter configuration controls. The step of adjusting the transparency of the edge region of the target dynamic image in response to the third operation for the gradient parameter configuration control includes: in response to a selection operation for a first parameter of the first gradient parameter configuration control, determining a first edge region of the target dynamic image according to the first parameter, where the first parameter is used to indicate a direction and a range of the first edge region; and adjusting a transparency of the first edge region.

The gradient parameter configuration control includes a second gradient parameter configuration control. The step of adjusting the transparency of the first edge region includes: in response to a selection operation for a second parameter of the second gradient parameter configuration control, determining a second edge region from the first edge region according to the second parameter, where the second parameter is used to indicate a range of the second edge region, and the second edge region is less than or equal to the first edge region; and adjusting a transparency of the second edge region, where a transparency value of a region closer to an edge of the second edge region is higher, and a transparency value of a region farther from the edge of the second edge region is lower.

The step of adjusting the transparency of the second edge region includes: obtaining a preset gradient material; assigning the gradient material to the first dynamic image through a preset rendering interface; and adjusting a transparency value corresponding to a pixel point of the second edge region through the gradient material, to enable the adjusted second edge region to be provided with a transparency gradient effect.

The step of adjusting the transparency value corresponding to the pixel point of the second edge region through the gradient material includes: sampling UV coordinates of a target pixel point of the second edge region through a shader for the gradient material; determining a distance value between the target pixel point and an edge pixel point of the second edge region according to the UV coordinates of the target pixel point; determining a target transparency value corresponding to the target pixel point according to the distance value and a preset control parameter; and adjusting a transparency value corresponding to the target pixel point of the second edge region to the target transparency value.

The graphical user interface further includes a static control and a picture saving control. After the step of displaying the edited target dynamic image on the preview interface in response to the first operation for the image editing control, the method further includes: in response to a trigger operation for the static control, obtaining a second target rendering texture by creating a second rendering texture and rendering an initial frame of the target dynamic image to the second rendering texture; determining the second target rendering texture as an initial frame picture; and in response to a trigger operation for the picture saving control, saving the initial frame picture.

The graphical user interface further includes a plurality of game background display controls, and the method further includes: in response to a trigger operation for a first game background display control in the plurality of game background display controls, displaying a screen of a first game background corresponding to the first game background display control in a background region of the graphical user interface.

The graphical user interface further includes a mirror control. After the step of rendering and displaying the first dynamic image corresponding to the first target resource on the graphical user interface based on the first rendering texture in response to the loading operation for the first target resource, the method further includes: in response to a trigger operation for the mirror control, obtaining a mirror image of the first dynamic image by flipping the first dynamic image; and displaying the mirror image of the first dynamic image.

The graphical user interface further includes a preview control. The method further includes: in response to a trigger operation for the preview control, displaying a game interface on the graphical user interface, where the game interface includes a resource loading control and a game scene screen; in response to a fourth operation for the resource loading control, loading a second target resource corresponding to the fourth operation and audio data corresponding to the second target resource, and displaying a second dynamic image corresponding to the second target resource on the game interface; and playing an action screen and a sound audio corresponding to the second dynamic image based on the second target resource and the audio data.

The second target resource includes a plurality of pre-generated mouth shape animations. The step of playing the action screen and the sound audio corresponding to the second dynamic image based on the second target resource and the audio data includes: obtaining a corresponding sound audio by parsing the audio data; determining a target mouth shape animation corresponding to each target audio in the sound audio from the plurality of mouth shape animations; and playing the action screen and the sound audio corresponding to the second dynamic image, and playing the target mouth shape animation corresponding to each target audio simultaneously.

The graphical user interface further includes a comparison control, and the method further includes: in response to a trigger operation for the comparison control, displaying a comparison interface on the graphical user interface, where the comparison interface includes a plurality of resource input controls, each resource input control is provided with a corresponding image display region and a loading control, and the resource input control is used for input of a resource number of a target resource; in response to a trigger operation for a loading control corresponding to the target resource input control, loading a third target resource corresponding to a resource number displayed by the target resource input control; and displaying a third dynamic image corresponding to the third target source in an image display region corresponding to the target resource input control.

The comparison interface further includes a plurality of selection controls, and each selection control corresponds to an image size. The method further includes: in response to a trigger operation for a first selection control in the plurality of selection controls, displaying a third dynamic image of a first image size corresponding to the first selection control in the image display region.

The comparison interface further includes a reference line control, and the method further includes: in response to a trigger operation for the reference line control, displaying a reference line corresponding to the reference line control on the comparison interface.

The comparison interface further includes a static image control, and the method further includes: in response to a trigger operation for the static image control, displaying an initial frame picture of the third dynamic image in the image display region.

After the step of displaying the edited target dynamic image on the preview interface in response to the first operation for the image editing control, the method further includes: in response to a saving operation for the target dynamic image, converting data information corresponding to the target dynamic image into a target code, and saving the target code in a preset configuration file.

In some embodiments, the electronic device shown in FIG. 15 further includes a bus 102 and a communication interface 103. The processor 100, the communication interface 103, and the memory 101 are connected through the bus 102.

In some embodiments, the memory 101 may include a high-speed random access memory (RAM), or may further include a non-volatile memory, such as at least one magnetic disk memory. The communication connection between the system network element and at least one other network element may be implemented by using at least one communication interface 103 (which may be wired or wireless), where the Internet, a wide area network, a local network, a metropolitan area network, or the like may be used. The bus 102 may be an ISA bus, a PCI bus, an EISA bus, or the like. The bus may be classified into an address bus, a data bus, a control bus, or the like. For ease of representation, only one bidirectional arrow is used to represent the bus in FIG. 15, but this does not mean that there is only one bus or one type of bus.

The processor 100 may be an integrated circuit chip, and has a signal processing capability. In an implementation process, steps of the foregoing methods may be completed by using an integrated logic circuit of hardware in the processor 100 or an instruction in a form of software. The processor 100 may be a general-purpose processor, including a Central Processing Unit (referred to as CPU), a Network Processor (referred to as NP), or the like. The processor 100 may also be a Digital Signal Processor (referred to as DSP), an Application Specific Integrated Circuit (referred to as ASIC), a Field-Programmable Gate Array (referred to as FPGA) or other programmable logic devices, discrete gates or transistor logic devices, discrete hardware components. The processor may implement or execute the methods, steps, and logical block diagrams disclosed in the embodiments of the present disclosure. The general-purpose processor may be a microprocessor, or the processor may be any conventional processor or the like. The steps of the methods disclosed with reference to the embodiments of the present disclosure may be directly performed and completed by a hardware decoding processor, or may be performed and completed by using a combination of hardware in a decoding processor of software modules. The software module may be located in a mature storage medium in the art, such as a random access memory, a flash memory, a read-only memory, a programmable read-only memory, an electrically erasable programmable memory, or a register. The storage medium is located in the memory 101. The processor 100 reads information in the memory 101 and completes the steps of the methods in the foregoing embodiments in combination with hardware of the processor 100.

According to the embodiment, there is further provided a non-transitory computer-readable storage medium, where the non-transitory computer-readable storage medium stores a computer-executable instruction, and when the computer-executable instruction is invoked and executed by the processor, the computer-executable instruction enables the processor to implement the foregoing method for dynamic image editing, In some embodiments, to implement the following method.

In response to a loading operation for a first target resource, a first dynamic image corresponding to the first target resource is rendered and displayed in the graphical user interface based on a first rendering texture; and in response to a first operation for the image editing control, an edited target dynamic image is displayed on the preview interface.

The step of rendering and displaying the first dynamic image corresponding to the first target resource in the graphical user interface based on the first rendering texture includes: loading the first target resource; obtaining a first target rendering texture by creating the first rendering texture and rendering the first target resource to the first rendering texture frame by frame; determining the first target rendering texture as the first dynamic image, and displaying the first dynamic image in a first display region of the graphical user interface; where a display priority of the first dynamic image is higher than a display priority of the image editing control, the first dynamic image includes a plurality of first dynamic images, and a size of each first dynamic image is different from each other.

The image editing control includes a first cropping control, and the step of displaying the edited target dynamic image on the preview interface in response to the first operation of the image editing control includes: in response to a trigger operation for the first cropping control, providing the first dynamic image on the preview interface, where the preview interface is provided with a cropping function; and cropping the preview interface according to the cropping function of the preview interface, and displaying a cropped target dynamic image on the preview interface.

The step of cropping the preview interface according to the cropping function of the preview interface, and displaying the cropped target dynamic image on the preview interface includes: obtaining a cropping region by cropping the preview interface according to the cropping function of the preview interface based on a cropping size corresponding to the first dynamic image, where the first dynamic image includes a plurality of first dynamic images, and a cropping size corresponding to each first dynamic image is different from each other; and determining a dynamic image within the cropping region as the target dynamic image, and displaying the target dynamic image in the cropping region.

The graphical user interface further includes a zoom control. After the step of determining the dynamic image within the cropping region as the target dynamic image and displaying the target dynamic image in the cropping region, the method further includes: in response to a second operation for the zoom control, adjusting a size of the first dynamic image according to a zoom parameter displayed by the zoom control; and adjusting the dynamic image displayed in the cropping region based on the size-adjusted first dynamic image.

After the step of determining the dynamic image within the cropping region as the target dynamic image and displaying the target dynamic image in the cropping region, the method further includes: in response to a position adjustment operation for the target dynamic image displayed in the cropping region, controlling the first dynamic image to move, and displaying position information of the moved first dynamic image; and adjusting the dynamic image displayed in the cropping region based on the moved first dynamic image.

The image editing control further includes a second cropping control and a third cropping control. After the step of determining the dynamic image within the cropping region as the target dynamic image and displaying the target dynamic image in the cropping region, the method further includes: in response to a trigger operation for the second cropping control, identifying and displaying the cropping region; in response to a trigger operation for the third cropping control, displaying an editing interface corresponding to a target cropping region, where the editing interface includes a parameter editing control and a determination control; and adjusting a size of the cropping region based on the parameter editing control and the determination control.

The step of adjusting the size of the cropping region based on the parameter editing control and the determination control includes: in response to an editing operation for the parameter editing control, determining a size parameter corresponding to the editing operation; and in response to a triggering operation for the determination control, updating a size of the target cropping region according to the size parameter, identifying and displaying the updated cropping region. The graphical user interface further includes a reference frame control and a reference frame hiding control. After the step of determining the dynamic image within the cropping region as the target dynamic image and displaying the target dynamic image in the cropping region, the method further includes: in response to a trigger operation for the reference frame control, displaying a reference frame corresponding to the reference frame control at a preset position in the cropping region; and in response to a trigger operation for the reference frame hiding control, cancelling display of the reference frame.

The graphical user interface further includes a gradient parameter configuration control. After the step of displaying the edited target dynamic image on the preview interface in response to the first operation for the image editing control, the method further includes: in response to a third operation for the gradient parameter configuration control, adjusting a transparency of an edge region of the target dynamic image.

The gradient parameter configuration control includes a plurality of first gradient parameter configuration controls. The step of adjusting the transparency of the edge region of the target dynamic image in response to the third operation for the gradient parameter configuration control includes: in response to a selection operation for a first parameter of the first gradient parameter configuration control, determining a first edge region of the target dynamic image according to the first parameter, where the first parameter is used to indicate a direction and a range of the first edge region; and adjusting a transparency of the first edge region.

The gradient parameter configuration control includes a second gradient parameter configuration control. The step of adjusting the transparency of the first edge region includes: in response to a selection operation for a second parameter of the second gradient parameter configuration control, determining a second edge region from the first edge region according to the second parameter, where the second parameter is used to indicate a range of the second edge region, and the second edge region is less than or equal to the first edge region; and adjusting a transparency of the second edge region, where a transparency value of a region closer to an edge of the second edge region is higher, and a transparency value of a region farther from the edge of the second edge region is lower.

The step of adjusting the transparency of the second edge region includes: obtaining a preset gradient material; assigning the gradient material to the first dynamic image through a preset rendering interface; and adjusting a transparency value corresponding to a pixel point of the second edge region through the gradient material, to enable the adjusted second edge region to be provided with a transparency gradient effect.

The step of adjusting the transparency value corresponding to the pixel point of the second edge region through the gradient material includes: sampling UV coordinates of a target pixel point of the second edge region through a shader for the gradient material; determining a distance value between the target pixel point and an edge pixel point of the second edge region according to the UV coordinates of the target pixel point; determining a target transparency value corresponding to the target pixel point according to the distance value and a preset control parameter; and adjusting a transparency value corresponding to the target pixel point of the second edge region to the target transparency value.

The graphical user interface further includes a static control and a picture saving control. After the step of displaying the edited target dynamic image on the preview interface in response to the first operation for the image editing control, the method further includes: in response to a trigger operation for the static control, obtaining a second target rendering texture by creating a second rendering texture and rendering an initial frame of the target dynamic image to the second rendering texture; determining the second target rendering texture as an initial frame picture; and in response to a trigger operation for the picture saving control, saving the initial frame picture.

The graphical user interface further includes a plurality of game background display controls, and the method further includes: in response to a trigger operation for a first game background display control in the plurality of game background display controls, displaying a screen of a first game background corresponding to the first game background display control in a background region of the graphical user interface.

The graphical user interface further includes a mirror control. After the step of rendering and displaying the first dynamic image corresponding to the first target resource on the graphical user interface based on the first rendering texture in response to the loading operation for the first target resource, the method further includes: in response to a trigger operation for the mirror control, obtaining a mirror image of the first dynamic image by flipping the first dynamic image; and displaying the mirror image of the first dynamic image.

The graphical user interface further includes a preview control. The method further includes: in response to a trigger operation for the preview control, displaying a game interface on the graphical user interface, where the game interface includes a resource loading control and a game scene screen; in response to a fourth operation for the resource loading control, loading a second target resource corresponding to the fourth operation and audio data corresponding to the second target resource, and displaying a second dynamic image corresponding to the second target resource on the game interface; and playing an action screen and a sound audio corresponding to the second dynamic image based on the second target resource and the audio data.

The second target resource includes a plurality of pre-generated mouth shape animations. The step of playing the action screen and the sound audio corresponding to the second dynamic image based on the second target resource and the audio data includes: obtaining a corresponding sound audio by parsing the audio data; determining a target mouth shape animation corresponding to each target audio in the sound audio from the plurality of mouth shape animations; and playing the action screen and the sound audio corresponding to the second dynamic image, and playing the target mouth shape animation corresponding to each target audio simultaneously.

The graphical user interface further includes a comparison control, and the method further includes: in response to a trigger operation for the comparison control, displaying a comparison interface on the graphical user interface, where the comparison interface includes a plurality of resource input controls, each resource input control is provided with a corresponding image display region and a loading control, and the resource input control is used for input of a resource number of a target resource; in response to a trigger operation for a loading control corresponding to the target resource input control, loading a third target resource corresponding to a resource number displayed by the target resource input control; and displaying a third dynamic image corresponding to the third target source in an image display region corresponding to the target resource input control.

The comparison interface further includes a plurality of selection controls, and each selection control corresponds to an image size. The method further includes: in response to a trigger operation for a first selection control in the plurality of selection controls, displaying a third dynamic image of a first image size corresponding to the first selection control in the image display region.

The comparison interface further includes a reference line control, and the method further includes: in response to a trigger operation for the reference line control, displaying a reference line corresponding to the reference line control on the comparison interface.

The comparison interface further includes a static image control, and the method further includes: in response to a trigger operation for the static image control, displaying an initial frame picture of the third dynamic image in the image display region.

After the step of displaying the edited target dynamic image on the preview interface in response to the first operation for the image editing control, the method further includes: in response to a saving operation for the target dynamic image, converting data information corresponding to the target dynamic image into a target code, and saving the target code in a preset configuration file.

The computer program product for the method for dynamic image editing, apparatus, electronic device, and system provided in the embodiments of the present disclosure includes a computer-readable storage medium storing program code, and the instruction included in the program code may be used to perform the methods in the foregoing method embodiments. For the specific implementation, reference may be made to the method embodiments, and details are not described here again.

It may be clearly understood by those skilled in the art that, for the purpose of convenient and brief description, for the detailed working process of the described system and apparatus, reference may be made to a corresponding process in the foregoing method embodiments, and details are not described here again.

In addition, in the description of the embodiments of the present disclosure, unless expressly specified and limited otherwise, the terms “install”, “join” and “connection” should be understood in a broad sense; for example, it may be a fixed connection, a detachable connection, or an integral connection; it may be a mechanical connection or an electrical connection; or it may be a direct connection, or may be an indirect connection by using an intermediate medium, or may be a internal communication between two elements. For those skilled in the art, the specific meanings of the above terms in the present disclosure may be understood according to specific situations.

When the functions are implemented in the form of a software functional unit that is sold or used as an independent product, the functions may be stored in a computer-readable storage medium. Based on such understanding, the technical solution of the present disclosure essentially or a part that contributes to the related art or a part of the technical solution may be embodied in the form of a software product. The computer software product is stored in a storage medium, and includes several instructions for enabling a computer device (which may be a personal computer, a server, or a network device) to perform all or part of the steps of the methods in the embodiments of the present disclosure. The foregoing storage medium includes various mediums that may store a program code, such as a USB flash drive, a removable hard disk, a read-only memory (ROM), a random access memory (RAM), a magnetic disk, or an optical disk.

In the description of the present disclosure, it should be noted that the orientation or position relationship indicated by the terms “center”, “upper”, “lower”, “left”, “right”, “vertical”, “horizontal”, “inner”, “outer” and the like is based on the orientation or position relationship shown in the accompanying drawings, which is only for the convenience of describing the present disclosure and simplifying the description, and does not indicate or imply that the device or component referred to must have a specific orientation, be constructed and operated in a specific orientation, and therefore cannot be understood as a limitation to the present disclosure. In addition, the terms “first”, “second” and “third” are used for descriptive purposes only and cannot be understood as indicating or implying relative importance.

Finally, it should be noted that, the above embodiments are only specific implementations of the present disclosure to illustrate the technical solutions of the present disclosure, but not to limit the technical solutions of the present disclosure, and the scope of protection of the present disclosure is not limited to this. Although the present disclosure is described in detail with reference to the foregoing embodiments, those skilled in the art should understand that, any technical personnel familiar with this art may still modify or easily think of variations of the technical solutions described in the foregoing embodiments within the technical scope disclosed in the present disclosure, or equivalently substitute some of the technical features therein. Such modifications, variations or substitutions that do not make the essence of technical solutions depart from the spirit and scope of the technical solutions of the embodiments of the present disclosure shall fall within the protection scope of the present disclosure. Therefore, the protection scope of the present disclosure shall be subject to the protection scope of the claims.

1. A method for dynamic image editing, comprising:
in response to a loading operation for a first target resource, rendering and displaying a first dynamic image corresponding to the first target resource in a graphical user interface based on a first rendering texture, wherein the graphical user interface is provided by a terminal device, and the graphical user interface comprises an image editing control and a preview interface; and
in response to a first operation for the image editing control, displaying an edited target dynamic image on the preview interface.

2. The method according to claim 1, wherein rendering and displaying the first dynamic image corresponding to the first target resource in the graphical user interface based on the first rendering texture comprises:
loading the first target resource; and
obtaining a first target rendering texture by creating the first rendering texture and rendering the first target resource to the first rendering texture frame by frame; and
determining the first target rendering texture as the first dynamic image, and displaying the first dynamic image in a first display region of the graphical user interface, wherein a display priority of the first dynamic image is higher than a display priority of the image editing control, the first dynamic image comprises a plurality of first dynamic images, and a size of each first dynamic image is different from each other.

3. The method according to claim 1, wherein the image editing control comprises a first cropping control; and
displaying the edited target dynamic image on the preview interface in response to the first operation for the image editing control comprises:
in response to a trigger operation for the first cropping control, providing the first dynamic image on the preview interface, wherein the preview interface is provided with a cropping function; and
cropping the preview interface according to the cropping function of the preview interface, and displaying a cropped target dynamic image on the preview interface;
wherein cropping the preview interface according to the cropping function of the preview interface, and displaying the cropped target dynamic image on the preview interface comprises:
obtaining a cropping region by cropping the preview interface according to the cropping function of the preview interface based on a cropping size corresponding to the first dynamic image, wherein the first dynamic image comprises a plurality of first dynamic images, and a cropping size corresponding to each first dynamic image is different from each other; and
determining a dynamic image within the cropping region as the target dynamic image, and displaying the target dynamic image in the cropping region.

4. (canceled)

5. The method according to claim 3, wherein the graphical user interface further comprises a zoom control; and
the method further comprises:
in response to a second operation for the zoom control, adjusting a size of the first dynamic image according to a zoom parameter displayed by the zoom control; and
adjusting the dynamic image displayed in the cropping region based on the size-adjusted first dynamic image.

6. The method according to claim 3, wherein after the step of determining the dynamic image within the cropping region as the target dynamic image and displaying the target dynamic image in the cropping region, the method further comprises:
in response to a position adjustment operation for the target dynamic image displayed in the cropping region, controlling the first dynamic image to move, and displaying position information of the moved first dynamic image; and
adjusting the dynamic image displayed in the cropping region based on the moved first dynamic image.

7. The method according to claim 3, wherein the image editing control further comprises a second cropping control and a third cropping control; and
the method further comprises:
in response to a trigger operation for the second cropping control, identifying and displaying the cropping region;
in response to a trigger operation for the third cropping control, displaying an editing interface corresponding to a target cropping region, where the editing interface comprises a parameter editing control and a determination control; and
adjusting a size of the cropping region based on the parameter editing control and the determination control.

8. The method according to claim 7, wherein the step of adjusting the size of the cropping region based on the parameter editing control and the determination control comprises:
in response to an editing operation for the parameter editing control, determining a size parameter corresponding to the editing operation; and
in response to a trigger operation for the determination control, updating a size of the target cropping region according to the size parameter, identifying and displaying the updated cropping region.

9. The method according to claim 4, wherein the graphical user interface further comprises a reference frame control and a reference frame hiding control; and
the method further comprises:
in response to a trigger operation for the reference frame control, displaying a reference frame corresponding to the reference frame control at a preset position in the cropping region; and
in response to a trigger operation for the reference frame hiding control, cancelling display of the reference frame.

10. The method according to claim 1, wherein the graphical user interface further comprises a gradient parameter configuration control; and the method further comprises:
in response to a third operation for the gradient parameter configuration control, adjusting a transparency of an edge region of the target dynamic image;
wherein the gradient parameter configuration control comprises a plurality of first gradient parameter configuration controls; and
adjusting the transparency of the edge region of the target dynamic image in response to the third operation for the gradient parameter configuration control comprises:
in response to a selection operation for a first parameter of the first gradient parameter configuration control, determining a first edge region of the target dynamic image according to the first parameter, wherein the first parameter is used to indicate a direction and a range of the first edge region; and
adjusting a transparency of the first edge region.

11. (canceled)

12. The method according to claim 10, wherein the gradient parameter configuration control comprises a second gradient parameter configuration control; and
adjusting the transparency of the first edge region comprises:
in response to a selection operation for a second parameter of the second gradient parameter configuration control, determining a second edge region from the first edge region according to the second parameter, wherein the second parameter is used to indicate a range of the second edge region, and the second edge region is less than or equal to the first edge region; and
adjusting a transparency of the second edge region, wherein a transparency value of a region closer to an edge of the second edge region is higher, and a transparency value of a region farther from the edge of the second edge region is lower;
wherein adjusting the transparency of the second edge region comprises:
obtaining a preset gradient material;
assigning the gradient material to the first dynamic image through a preset rendering interface; and
adjusting a transparency value corresponding to a pixel point of the second edge region through the gradient material, to enable the adjusted second edge region to be provided with a transparency gradient effect.

13. (canceled)

14. The method according to claim 12, wherein adjusting the transparency value corresponding to the pixel point of the second edge region through the gradient material comprises:
sampling UV coordinates of a target pixel point of the second edge region through a shader for the gradient material;
determining a distance value between the target pixel point and an edge pixel point of the second edge region according to the UV coordinates of the target pixel point;
determining a target transparency value corresponding to the target pixel point according to the distance value and a preset control parameter; and
adjusting a transparency value corresponding to the target pixel point of the second edge region to the target transparency_value.

15. The method according to claim 1, wherein the graphical user interface further comprises a static control and a picture saving control; and
the method further comprises:
in response to a trigger operation for the static control, obtaining a second target rendering texture by creating a second rendering texture and rendering an initial frame of the target dynamic image to the second rendering texture;
determining the second target rendering texture as an initial frame picture; and
in response to a trigger operation for the picture saving control, saving the initial frame picture.

16. The method according to claim 1, wherein the graphical user interface further comprises a plurality of game background display controls, and the method further comprises:
in response to a trigger operation for a first game background display control in the plurality of game background display controls, displaying a screen of a first game background corresponding to the first game background display control in a background region of the graphical user interface.

17. The method according to claim 1, wherein the graphical user interface further comprises a mirror control; and
the method further comprises:
in response to a trigger operation for the mirror control, obtaining a mirror image of the first dynamic image by flipping the first dynamic image; and
displaying the mirror image of the first dynamic image.

18. The method according to claim 1, wherein the graphical user interface further comprises a preview control, and the method further comprises:
in response to a trigger operation for the preview control, displaying a game interface on the graphical user interface, wherein the game interface comprises a resource loading control and a game scene screen;
in response to a fourth operation for the resource loading control, loading a second target resource corresponding to the fourth operation and audio data corresponding to the second target resource, and displaying a second dynamic image corresponding to the second target resource on the game interface; and
playing an action screen and a sound audio corresponding to the second dynamic image based on the second target resource and the audio data.

19. The method according to claim 18, wherein the second target resource comprises a plurality of pre-generated mouth shape animations; and
playing the action screen and the sound audio corresponding to the second dynamic image based on the second target resource and the audio data comprises:
obtaining a corresponding sound audio by parsing the audio data;
determining a target mouth shape animation corresponding to each target audio in the sound audio from the plurality of mouth shape animations; and
playing the action screen and the sound audio corresponding to the second dynamic image, and playing the target mouth shape animation corresponding to each target audio simultaneously.

20. The method according to claim 1, wherein the graphical user interface further comprises a comparison control, and the method further comprises:
in response to a trigger operation for the comparison control, displaying a comparison interface on the graphical user interface, wherein the comparison interface comprises a plurality of resource input controls, each resource input control is provided with a corresponding image display region and a loading control, and the resource input control is used for input of a resource number of a target resource;
in response to a trigger operation for a loading control corresponding to the target resource input control, loading a third target resource corresponding to a resource number displayed by the target resource input control; and
displaying a third dynamic image corresponding to the third target source in an image display region corresponding to the target resource input control;
wherein the comparison interface further comprises a plurality of selection controls, each selection control corresponds to an image size, and the method further comprises: in response to a trigger operation for a first selection control in the plurality of selection controls, displaying a third dynamic image of a first image size corresponding to the first selection control in the image display region;
wherein the comparison interface further comprises a reference line control, and the method further comprises: in response to a trigger operation for the reference line control, displaying a reference line corresponding to the reference line control on the comparison interface; and
wherein the comparison interface further comprises a static image control, and the method further comprises: in response to a trigger operation for the static image control, displaying an initial frame picture of the third dynamic image in the image display region.

21. (canceled)

22. (canceled)

23. (canceled)

24. The method according to claim 1, wherein the method further comprises:
in response to a saving operation for the target dynamic image, converting data information corresponding to the target dynamic image into a target code, and saving the target code in a preset configuration file.

25. (canceled)

26. An electronic device, comprising a processor and a memory, wherein the memory stores a computer-executable instruction executable by the processor, and the processor executes the computer-executable instruction to implement the method for dynamic image editing according to any one of claims 1 to 24 a method for dynamic image editing, a graphical user interface being provided by a terminal device, the graphical user interface comprising an image editing control and a preview interface, and the method comprising:
in response to a loading operation for a first target resource, rendering and displaying a first dynamic image corresponding to the first target resource in the graphical user interface based on a first rendering texture; and
in response to a first operation for the image editing control, displaying an edited target dynamic image on the preview interface.

27. A non-transitory computer-readable storage medium, wherein the non-transitory computer-readable storage medium stores a computer-executable instruction, and when the computer-executable instruction is invoked and executed by a processor, the computer-executable instruction enables the processor to implement a method for dynamic image editing, a graphical user interface being provided by a terminal device, the graphical user interface comprising an image editing control and a preview interface, and the method comprising:
in response to a loading operation for a first target resource, rendering and displaying a first dynamic image corresponding to the first target resource in the graphical user interface based on a first rendering texture; and
in response to a first operation for the image editing control, displaying an edited target dynamic image on the preview interface.
